(19) United States
(12) Patent Application Publication
(10) Pub. No.: US 2005/0246350 A1
(43) Pub. Date: Nov. 3, 2005

(54) System and method for classifying and normalizing structured data

(75) Inventor: Vishvas T. Canaran, Jacksonville, FL (US)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: Opence Inc.

(21) Appl. No.: 10/834,880

(22) Filed: Apr. 30, 2004

(51) Int. Cl. G06F 7/00

(52) U.S. Cl. 707/100

(57) ABSTRACT

Embodiments of the invention generally relate to a method of processing data. The method includes receiving at least one structured data item and applying at least one processing rule to said at least one structured data item. The method also includes determining an anomaly associated with the at least one structured data item in response to the at least one structured data item matching a condition in said at least one processing rule. The method also includes appending the anomaly to a database of anomalies.

### CROSS-REFERENCE TO RELATED APPLICATIONS

This application relates to co-pending U.S. patent application Ser. No. 10/______, entitled, “SYSTEM AND METHOD FOR MIXED-LANGUAGE EDITING” filed concurrently herewith and co-pending U.S. patent application Ser. No. 10/______, entitled, “SYSTEM AND METHOD FOR DOCUMENT VALIDATION”, filed concurrently herewith, all co-pending applications are hereby incorporated by reference in their entirety.

### BACKGROUND OF THE RELATED ART

Many companies use business performance management (“BPM”) as a way to focus on core competencies and to lower costs. These companies initially outsource human resources (“HR”) then payroll and then rapidly move benefits, time and expense and other non-core, e.g., administrative, business functions to BPM companies. Companies have also used BMP in insurance, i.e., processing claims in disaster recovery, property, casualty, etc. The processing of insurance claims is very similar to processing benefit claims in the HR space. Other companies have started using BPM in other areas of business, e.g., enterprise resource planning (“ERP”), customer relationship management (“CRM”), supply chain management (“SCM”).

The BPM companies typically set up service centers in a remote location to service their clients. The remote location is selected based on finding lower costs for personnel, software, and/or hardware. For example, the BPM companies have used countries with a low cost of living, e.g., India, as a way to lower personnel, hardware, and/or transmission costs. Since BPM companies typically purchase large quantities of software in servicing their companies, BPM companies use their bulk-purchasing power as another way to lower costs on software and/or hardware. The BPM companies typically earn their profit margins from the reselling of the per-seat licenses of the purchased of software and/or hardware systems.

However, there are drawbacks and disadvantages to this approach for BPM companies. For example, BPM companies may have trouble being competitive with each other and against in-house services of large organizations. Large organizations can achieve similar deals as BPM companies for software, hardware, and software. A large organization may have many smaller branch offices that cannot afford to purchase off-the-shelf software directly or hosted by a BPM company. Moreover, a substantial portion of the profit margin of a BPM company may be balanced against the integration costs of back-end systems at the clients and/or customizing the BPM's systems to match the needs of the client.

A BPM company has to resolve several issues of efficiency in order to remain a profitable business model. For example, a BPM company has to be able increase the efficiency of service center personnel without increasing the need for personnel as the number of clients increase. The BPM company also has to be able to integrate to a variety of backend systems of the customers quickly and without relying on third party expertise. The BPM company further has to be able to provide an alternative to expensive software and/or hardware systems for small customers and/or small satellite offices of large clients.

One solution to the increasing employee efficiency requires systems in the service center that permit an employee to work on many clients at the same time, where each client often has specific software requirements. Most service center employees spend a majority of their time identifying and responding to bad data and transactions for the client. Thus, in order to serve multiple clients, the service center employee has to be familiar with various types of software packages. Accordingly, a consolidated and consistent management interface and software processing that identifies errors automatically has to be achieved in order to provide a solution to increasing employee efficiency.

The solution to integrating quickly with backend systems of clients requires specialized data integration driven by client requirements. This solution also requires the creation of specialized user interfaces and processing rules to find errors in the incoming data. Enterprise application integration (“EAI”) solutions are a method to resolve integration issues. EAI platforms, e.g., BEA's Weblogic Integration Server, can assist BPM companies connect to a client's backend system and transform the data. However, EAI solutions require the use of developers to define the data formats for the client and the BPM company. Thus, the developers add time and costs for the BPM company. Moreover, the EAI solutions are limited in their capabilities to detect errors or generate user interfaces for service center employees to input transactions, independent of the customer or client backend system.

### SUMMARY OF THE INVENTION

An embodiment of the invention generally relates to a method of processing data. The method includes receiving at least one structured data item and applying at least one processing rule to said at least one structured data item. The method also includes determining an anomaly associated with the at least one structured data item in response to the at least one structured data item matching a condition in the at least one processing rule. The method also includes appending the anomaly to a database of anomalies.

Another embodiment of the invention generally pertains to a system for processing structured data. The system includes a processing rule module configured to store at least one processing rule, each processing rule configured to detect an anomaly. The system also includes an anomaly engine configured to receive at least one structured data element. The anomaly engine is also configured to determine a nearness vector for the at least one structured data element. The anomaly engine is further configured to select a subset of processing rules based on a comparison of the nearness vector for the at least one structured data element and the respective nearness vectors of the subset of processing rules being within a predetermined value.

Yet another embodiment of the invention generally relates to a computer readable storage medium on which is embedded one or more computer programs. The one or more computer programs implement a method of processing structured data. The one or more computer programs include a set of instructions for receiving at least one structured data element and maintaining a plurality of nearness vector for a plurality of processing rules. Each nearness vector is associated with a respective processing rule. The set of instructions also include determining a nearness vector for at least one structured data element. The set of instructions further include selecting a subset of processing rules based on the nearness vector for the at least one structure data element and the associated nearness vectors for the subset of processing rules being within a predetermined value.

Yet another embodiment of the invention generally pertains to a means for processing data. The apparatus includes means for receiving at least one structured data item and means for applying at least one processing rule to said at least one structured data item. The apparatus also includes means for determining an anomaly associated with said at least one structured data item in response to said at least one structured data item matching a condition in said at least one processing rule. The apparatus further includes means for appending the anomaly to a database of anomalies.

### BRIEF DESCRIPTION OF THE DRAWINGS

While the specification concludes with claims particularly pointing out and distinctly claiming the present invention, it may be believed the same will be better understood from the following description taken in conjunction with the accompanying drawings, which illustrate, in a non-limiting fashion, the best mode presently contemplated for carrying out the present invention, and in which like reference numerals designate like parts throughout the figures, wherein:

FIG. 1 illustrates a block diagram of a system using an intelligent processor module (IPM) in accordance with an embodiment of the invention;

FIG. 2 illustrates a more detailed block diagram of the IPM, shown in FIG. 1, in accordance with another embodiment of the invention;

FIG. 3 illustrates a block diagram of the anomaly engine, shown in FIG. 2, in accordance with yet another embodiment of the invention;

FIG. 4 illustrates a flow diagram for the processing of structured data by the anomaly engine processor, shown in FIG. 3, in accordance with yet another embodiment of the invention;

FIG. 5 illustrates a flow diagram for the pattern-matching module, shown in FIG. 3, in accordance with yet another embodiment of the invention;

FIG. 6 illustrates a flow diagram for the IVA, shown in FIG. 3, in accordance with yet another embodiment of the invention; and

FIG. 7 illustrates a computer system implementing the anomaly engine in accordance with yet another embodiment of the invention.

### DETAILED DESCRIPTION OF THE EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, many types of systems for processing structured data, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments of the present invention generally relate to a system for processing multiple types of structured data and semi-structured data, e.g., a document (or XML fragment) that has at least one element referring to a binary large object, that allows for dynamic adaptation and defect management of the structured data. More particularly, an intelligent processor module (IPM) may be configured to receive many types of structured data, e.g., an XML document. The IPM may process the received structured data against a set of processing rules.

The processing rules may be configured to detect defects, errors, or anomalies in the syntax and structure as well as perform higher logic functions to detect anomalies in the received data. The processing rules may be predetermined and dynamically adapted as the IPM processes the received structured data.

The IPM may also be configured to output the detected anomalies for a user to view the data. The IPM may be further configured to communicate with third party computer systems that may provide the data and/or consume the processed data.

Another embodiment of the invention generally pertains to a method, apparatus and/or system for dynamic adaptation of the processing rules. More specifically, the IPM includes an anomaly engine configured to analyze the data for anomalies. The anomaly engine may interface with a processing rules module configured to store the processing rules for the IPM. The anomaly engine may access the processing rules module to process received structured data. The processing rules module may also interface with a pattern-matching module, an intelligent virtual agent and a schema editor.

The anomaly engine may also implement a classification model for the received structured and/or semi-structured data. More particularly, the anomaly engine may apply XML techniques to generate a hierarchal abstraction of the received data. The pattern-matching module may then use the classification model to determine the nearest self-organized domain map. In one embodiment, the domain maps are a hierarchal representation of the grammar, processing rules and data for a particular application being serviced by the IPM. The detection process may be implemented using neural nets, graph theory or other similar pattern recognition algorithms known to those skilled in the art. The use of the hierarchal abstraction enables a greater chance of matching a known pattern against the domain maps.

The pattern-matching module may also be configured to develop rules based on the detected patterns. For example, when the pattern-matching module detects that employees of a company have salaries within a range, the pattern-matching module creates a rule where the employees of the company are within the range. The pattern-matching module then forwards the rule to the processing rules module to be included in future processing by the anomaly engine. In another embodiment, the frequency of certain structured data (fragment or document) may generate exceptions by the anomaly engine processor. Policies that are generated from the analysis of a series of recommendations and the workflows to implement the recommendations may then be implemented by the IPM. Accordingly, the IPM may be biased into a learned habit or behavior by implementing the generated policies.

The intelligent virtual agent (“IVA”) may be configured to dynamically create additional processing rules by monitoring a human agent. The IVA may mimic the action as the human agent responds to an anomaly generated by the anomaly engine. From the course of actions of the human agent, the IVA may create a rule. The IVA may then forward the rule to the processing rules module to be included in subsequent processing of the structured data by the anomaly engine. In other embodiments, the IVA may query the human agent in order to develop processing rules.

The schema editor may be configured to provide a mechanism for users to enter processing rules into the processing rules module. The schema editor may be implemented using a what-you-see-is-what-you-get (“WYSIWYG”) mixed-language editor as described by U.S patent application Ser No., 10/______, entitled “System and Method for Mixed-Language Editing”, filed concurrently herewith, and is incorporated in its entirety.

Yet another embodiment of the invention generally pertains to a method, system and/or apparatus for processing structured data against processing rules by an anomaly engine. The anomaly engine may be configured to determine a nearness vector for an incoming structured data, e.g., an XML document, an HTML document, an XHTML document, etc. The anomaly engine may also be configured to maintain a nearness vector for each processing rule stored in the processing rules module. The anomaly engine may then compare the nearness vector the incoming data with the nearness vectors of the processing rules. The anomaly processes the incoming data against the rules that are nearest to the incoming data. Accordingly, the IPM may receive different types of structured data and efficiently process the structured data.

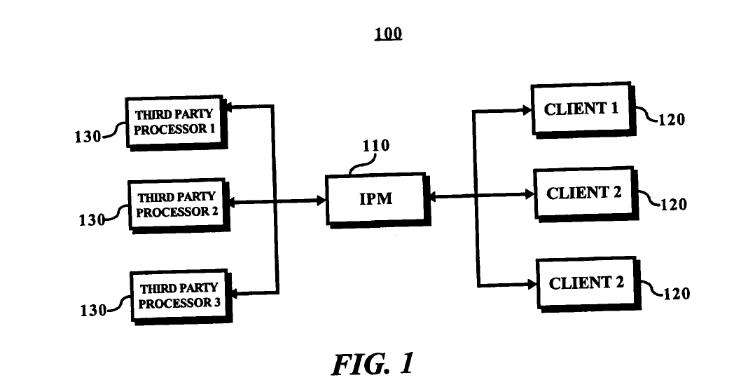

FIG. 1 illustrates a block diagram of a system 100 using an intelligent processor module (IPM) in accordance with an embodiment of the invention. It should be readily apparent to those of ordinary skill in the art that the system 100 depicted in FIG. 1 represents a generalized schematic illustration and that other components may be added or existing components may be removed or modified. Moreover, the system 100 may be implemented using software components, hardware components, or a combination thereof.

As shown in FIG. 1, the system 100 includes an intelligent processor module (labeled as “IPM” in FIG. 1) 110, clients 120, and third party processors 130. The IPM 110 may be configured to receive data from the clients 120 and to determine whether anomalies exist in the received data. After anomaly processing, the IPM 110 may route the data to the appropriate third party processor 130 for subsequent processing. The IPM 110 may also provide a platform to create user interfaces for creating of processing rules for detecting anomalies and to input data.

The IPM 110 may also dynamically adapt to the received data. More specifically, in certain embodiments, the IPM 110 may create new rules based on detecting patterns in the data and/or a human service center agent responding to an anomaly. Accordingly, the IPM may dynamically reconfigure itself to changing conditions to improve the detection of anomalies and thereby reduce the need for additional personnel in the service center.

The clients 120 may interface with the IPM 110 over local area networks, wide area networks or some combination thereof. The clients 120 may use the IPM 110 to outsource business processes such as payroll processing, insurance claims processing, benefits processing, etc. Each client 120 may be an individual company or divisions of a large organization located in multiple jurisdictions, i.e., many countries.

The third party processors 130 may also interface with the IPM 110. The third party processors 130 may provide services, e.g., payroll, electronic find transfers, claim processing, etc. to the IPM 110. The IPM 110 may function as an intermediary between clients 120 and the third party processors 130, thus providing economies of scale by reusing integrations to external third party processors 130 and calculation engines.

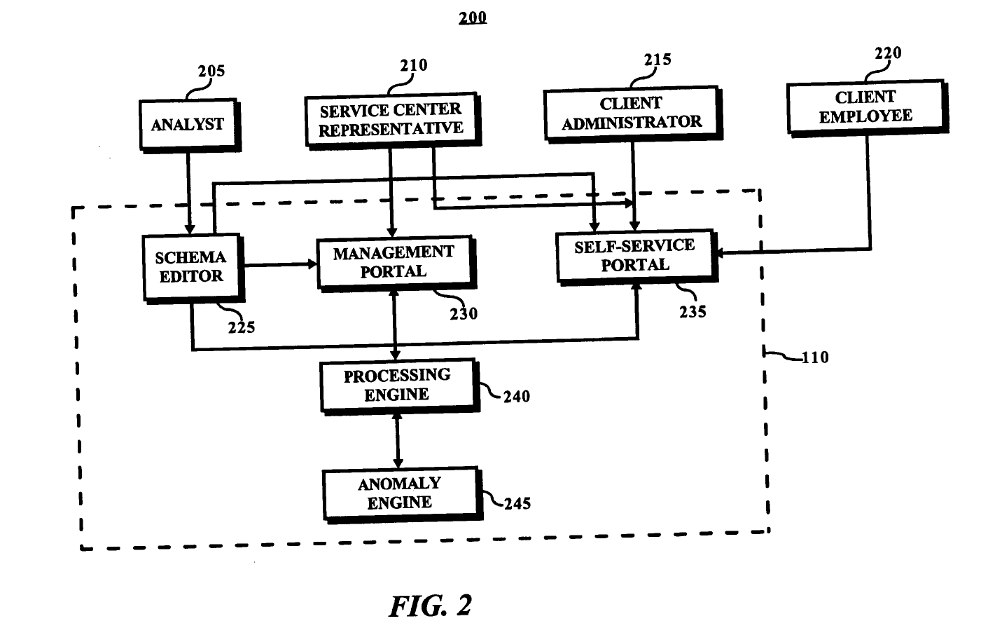

FIG. 2 illustrates a block diagram a system 200 utilizing the IPM 110, shown in FIG. 1, in accordance with another embodiment of the invention. It should be readily apparent to those of ordinary skill in the art that the system 200 depicted in FIG. 2 represents a generalized schematic illustration and that other components may be added or existing components may be removed or modified. Moreover, the IPM 110 may be implemented using software components, hardware components, or a combination thereof.

As shown in FIG. 2, the system includes an analyst 205, a service center representative 210, a client administrator 215, a client employee 220, and the IPM 110. The IPM 110 may include a schema editor 225, a management portal 230, a self-service portal 235, a processing engine 240, and an anomaly engine 245.

The analyst 205 may be an employee of a service center that implements the integration of new clients into the service center. The analyst 205 may use the schema editor 225 to define the metadata for the new customers.

The service center representative 210 may be an employee of the service center that administers the business processes that are outsourced. The service center representative 210 may interact with the IPM 110 by using the management portal 230. For example, the service center representative 210 may enter transactions and/or view reports generated by the IPM 110.

The client administrator 215 may be an individual at a client of the service center responsible for managing the outsourcing relationship. For example, in the outsourcing of human resources, the client administrator 215 is typically a human resource person. The client administrator 215 may enter transactions and/or view reports generated by the IPM 110.

The client employee 220 may be an employee at the client of the service center. The client employee 220 interacts with the IPM 110 by using the self-service portal 235. The client employee 220 may be constrained with a limited set of transactions. For example, a client employee 220 may submit a request to view cumulative pay for the year or to view a payroll stub for human resources outsourcing.

The schema editor 225 may be configured to allow analysts and developers to create the metadata and configuration information for the IPM 110. The schema editor 225 may be implemented using a mixed-language WYSIWYG editor as described by U.S. patent application Ser. No. 10/______, entitled “System and Method For Mixed Language Editing”, filed concurrently herewith, and is hereby incorporated in its entirety.

The management portal 230 may be configured as a tool for the service center representative 210 to manage the processing of data and the actions based on anomalies found in the data.

The self-service portal 235 may be configured as a programmable database and portal for self-service for the client administrator 215 and the client employee 220. In some embodiments, the self-service portal 235 may be created using a mixed-language WYSIWYG editor as described in the U.S. patent application Ser. No. 10/______, entitled “System and Method for Mixed-Language Editing”, filed concurrently, and hereby incorporated in its entirety.

The processing engine 240 may be configured to communicate with the different backend systems of the third party processors and clients. The processing engine 240 may also be configured to store transactions and to use the anomaly engine 245 to process the transactions.

The anomaly engine 245 may be, but not limited to being, configured to be a component used to execute a variety of processing rules on the data to detect anomalies. The anomalies may be in the syntax and structure in the data as well as in the data, i.e., a data value inconsistent with other similar data values. Portions of the anomaly engine 245, if not all, may be implemented using the validation component as described in U.S. patent application Ser. No. 10/______, entitled, “System and Method For Document Validation”, filed concurrently herewith and is incorporated in its entirety. The anomaly engine 245 may also be configured to dynamically add processing rules as it processes data as described above and herein below.

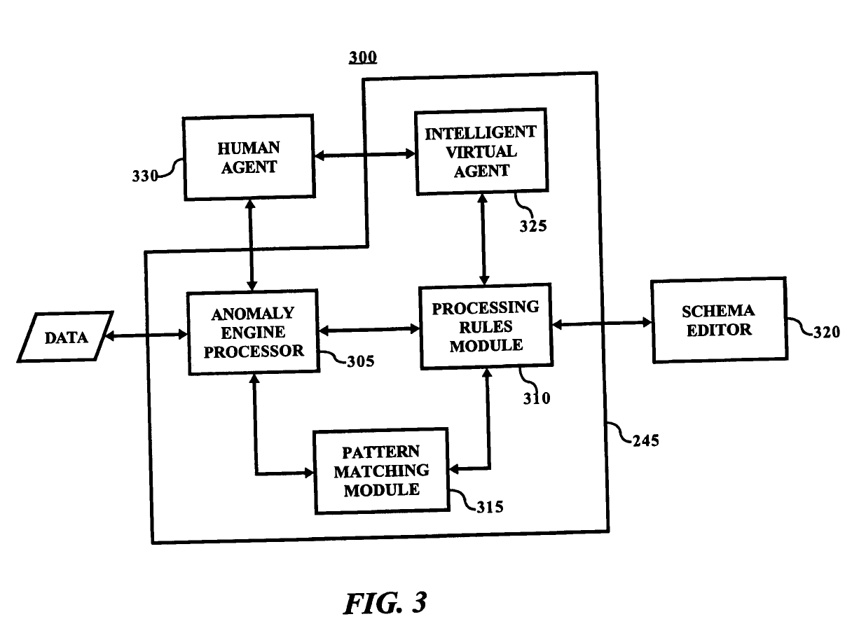

FIG. 3 illustrates a block diagram of the anomaly engine 245, shown in FIG. 2, in accordance with yet another embodiment of the invention. It should be readily apparent to those of ordinary skill in the art that the anomaly engine 245 depicted in FIG. 3 represents a generalized schematic illustration and that other components may be added or existing components may be removed or modified. Moreover, the anomaly engine 245 may be implemented using software components, hardware components, or a combination thereof.

As shown in FIG. 3, the anomaly engine 245 may include an anomaly engine processor 305, a processing rules module 310, and a pattern-matching module 315. The anomaly engine processor 305 may be, but not limited to being, configured to receive data in a structured form, e.g., an XML document, from the processing engine 240. The anomaly engine processor 305 may also be configured to determine the “closest” or “nearest” rules that may apply to the received structured document. The anomaly engine processor 305 may then apply the nearest rule(s) to the received structured document without processing every processing rule, thereby increasing efficiency.

One advantage of embodiments of the present invention is that processing rules for a variety of applications, e.g., human resources, CRM, SCM, insurance, etc., may be entered into the processing rules module 310. The processing engine 240 may accept all types of structured documents or pieces of structured data, i.e., at least one metadata and associated value, for all the programmed applications and process the structured document without reconfiguration. Thus, the processing engine 240 may increase its availability and efficiency.

In one embodiment, the anomaly engine processor 305 may also be configured to form a nearness vector for the received structured data. More specifically, the received structured data may be abstracted into a graph representation by equating the metadata and associated data as nodes and segments, respectively. Weights may be assigned to the node/segments based on a predetermined algorithm, historical data, etc.

The anomaly engine processor 305 may then use the nearness vector to search for processing rules that are within a predetermined “nearness” of the nearness vector in the processing rules module 310. The anomaly engine processor 305 may apply the selected processing rules to the received structured data to determine anomalies.

Subsequently, the anomaly engine processor 305 may use the nearness vector of the structured data to determine any recommendations and/or rules. More particularly, the anomaly engine processor 305 may also maintain self-domain maps (or templates) for the applications being served by the IPM 110. For example, for an insurance application, the anomaly engine processor 305 may have a template for processing car claims, home claims, disaster claims, etc. Each of the templates may contain a grammar, processing rules, and historical data for the respective application. Since data contained in the templates may also be structured data, a template may be abstracted to a graph.

The anomaly engine processor 305 may use the pattern-matching module 315 to select the appropriate template. More specifically, the patter-matching module 315 may comprise of neural nets to select the appropriate template for the nearness vector and to provide automated defect management. More specifically, the neural nets may be configured to determine how “near” the nearness vector is to the selected template. From the differences, the neural nets may be configured to provide actions (or recommendations) based on, in part, of the historical data contained in the template. For example, a structure data element containing expense data is analyzed by the pattern-matching module 315 against an expense template. The data may have a value, e.g., a meal expense that is three times the historical value of meal expense contained in the expense template. The neural nets of the pattern-matching module 315 may generate an action identifying the anomaly as well as a recommendation for the anomaly. For example, the recommendation may be paying the historical average and requesting additional justification for the expense.

In another embodiment, the anomaly engine processor 305 may use vector space analysis to determine the nearness to processing rules. More particularly, the anomaly engine processor 305 may convert the received structured document into a vector representation. The vector representation may be based on binary weights, raw term frequency, derived thesaurus terms, etc. The anomaly engine processor 305 may determine a similarity score for the vector representation of the received structured document with vector representation of the processing rules. The vector representations of the processing rules may be stored with the rules processing module 310 in some embodiments. The similarity score may be determined using simple matching, Dice's coefficient, Jaccard's coefficient, Cosine coefficient, Overlap coefficient, or other quantitative process. The processing rules with a similarity score within a predetermined value (or range) are selected for processing by the anomaly engine processor 305.

In yet another embodiment, the anomaly engine processor 305 may also use vector space processing to determine the template. More specifically, the data elements in a template may also be represented in vector representation. Accordingly, a template may then comprise a group of similar vectors. The vector representation of the structured data may then be hashed to select the correct template.

The anomaly engine processor 305 may be configured to interface with the processing rules module 310. The processing rules module 310 may be, but not limited to being, configured to store processing rules for the anomaly engine 245. The processing module 310 may store a plurality of processing rules. In some embodiments, the each processing rule may have an associated nearness vector, which may be calculated by the anomaly engine processor 305 as described above or predetermined during configuration of the processing engine 240. The processing rules and associated nearness vector may be stored and accessed using conventional database techniques, a linked list or other similar data structure.

The processing rules module 310 may also be configured to interface with a schema editor 320. The schema editor 320 may provide a means for users to input processing rules into the processing rules module 310.

The anomaly engine processor 305 may be further configured to interface with the pattern-matching module 315. The pattern-matching module 315 may be, but not limited to being, configured to detect patterns in the structured data processed by the anomaly engine processor 305. The pattern-matching module 315 may be implemented using conventional data mining processors and neural nets.

The pattern-matching module 315 may also be configured to develop rules based on the detected patterns. The newly developed rules are then forwarded to the processing rules module 310 to be included in subsequent processing of data by the anomaly engine processor 305.

The processing rules module 310 may be further configured to interface with an intelligent virtual agent (“IVA”) 325. The IVA 325 may be configured to monitor the human agent 330. More particularly, the WVA 325 may monitor how the expert, i.e., human agent 330 responds to anomalies presented to by the anomaly engine processor 305. The IVA 325 may mimic the actions of the human response, i.e., screen capture, keystroke capture, etc., and develop processing rules based on the mimicked actions. Alternatively, the WVA 325 may query the human a gent 330 on the response to the anomaly and develop additional processing rules based on the response. The IVA 325 may then forward the developed processing rules to the processing rules module 310 for subsequent processing of data by the anomaly engine processor 305.

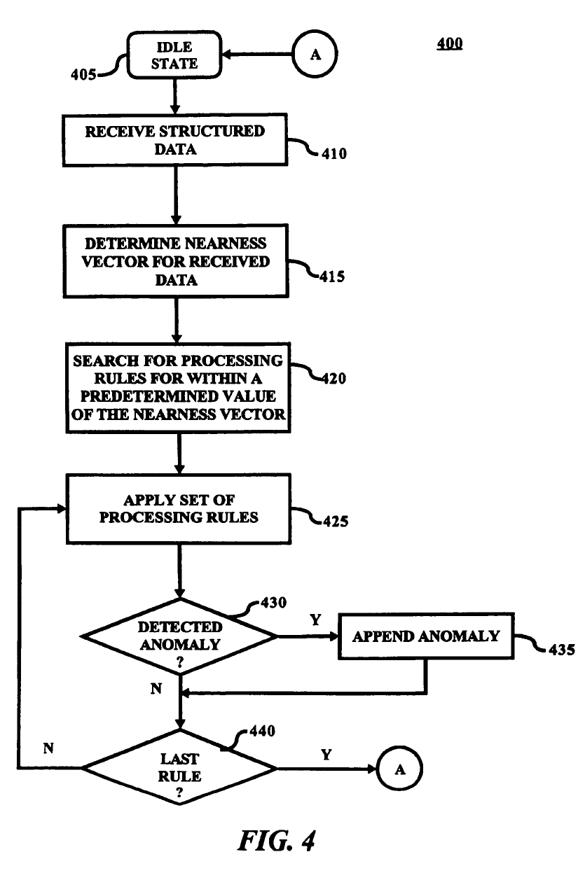

FIG. 4 illustrates a flow diagram 400 for the processing of structured data by the anomaly engine processor 305, shown in FIG. 3, in accordance with yet another embodiment of the invention. It should be readily apparent to those of ordinary skill in the art that this flow diagram 400 shown in FIG. 4 represents a generalized illustration and that other steps may be added or existing steps may be removed or modified.

As shown in FIG. 4, the anomaly engine processor 305 may be in an idle state, in step 405. The processing engine 245 (shown in FIG. 2) may forward structured data, e.g., an XML document, XHTML document, etc., comprising of at least one data element. In step 410, the anomaly engine processor 305 receives the structured data for processing.

In step 415, the anomaly engine processor 305 may calculate a nearness vector for the structured data. The anomaly engine processor 305 may abstract the metadata and associated data value of the received structured data into nodes and segments, respectively. The anomaly engine processor 305 may assign weights to the nodes and segments based on a predetermined heuristic, historical data, or other similar manner.

In step 420, the anomaly engine processor 305 may access the processing rules module 310 to search for a set of processing rules that are within a predetermine value of the calculated nearness vector for the structured data. In some embodiments, each of the processing rules stored in the processing rules module 310 may have an associated nearness vector. Thus, the anomaly engine processor 305 may use a hash function to determine at least one processing rule that is applicable to the structured data.

In step 425, the anomaly engine processor 305 may apply the set of processing rules near to the structured data. In one embodiment, anomaly engine processor 305 may execute each processing rule sequentially. In other embodiments, the processing rules may be linked for execution in a predetermined order.

In step 430, the anomaly engine processor 305 may determine whether an anomaly has been detected by the applied processing rule. If an anomaly has been detected, the anomaly engine processor 305 may append the anomaly to a listing of anomalies or to a database of anomalies, in step 435. Subsequently, the list of anomalies may be formatted to a single predetermined format for a user to analyze. The anomaly engine processor 305 may then proceed to the processing of step 440, as described herein below.

Otherwise, if an anomaly has not been detected for the selected processing rule, the anomaly engine processor 305 may be configured to determine whether the last rule in the set of processing rules has been reached, in step 440. If the last processing rule has been reached the anomaly engine processor 305 returns to the idle state of step 405. Otherwise, if the anomaly engine processor 305 has not applied the last processing rule, the anomaly engine processor 305 returns to the processing of step 420, described above.

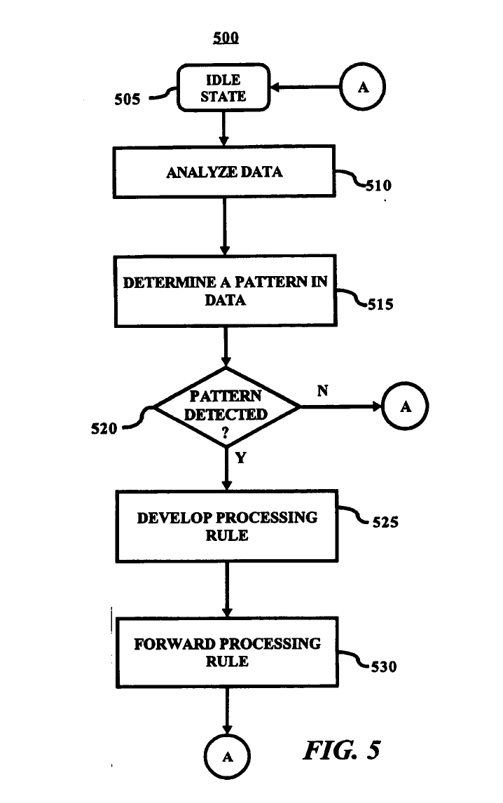

FIG. 5 illustrates a flow diagram 500 for the pattern-matching module 315, shown in FIG. 3, in accordance with yet another embodiment of the invention. It should be readily apparent to those of ordinary skill in the art that this flow diagram 500 shown in FIG. 5 represents a generalized illustration and that other steps may be added or existing steps may be removed or modified.

As shown in FIG. 5, the pattern-matching module 315 may be configured to be in an idle state, in step 505. The anomaly engine processor 305 may receive structured data forwarded by the processing engine 240.

In step 510, the pattern-matching module 315 may be configured to analyze the structured data. In some embodiments, the pattern-matching module 315 may maintain a database that tracks previous instances of the structured data.

In step 515, the pattern-matching module 315 may be configured to determine any patterns in the structured data by data mining and/or neural nets. In step 520, the pattern-matching module 315 may determine whether there has been a pattern detected. If the pattern-matching module 315 has not detected a pattern, the pattern-matching module 315 may return to the idle state of step 505.

Otherwise, if the pattern-matching module 315 determines a pattern, the pattern-matching module 315 may be configured to develop a rule in response to the detected pattern, in step 525. For example, neural nets may be trained to develop rules based on detected pattern between the nearness vector and its selected template.

In step 530, the pattern-matching module 315 may be configured to forward the developed processing rule to the processing rules module 310 for subsequent processing by the anomaly engine processor 305. Subsequently, the pattern-matching module 315 may return to the idle state of step 505.

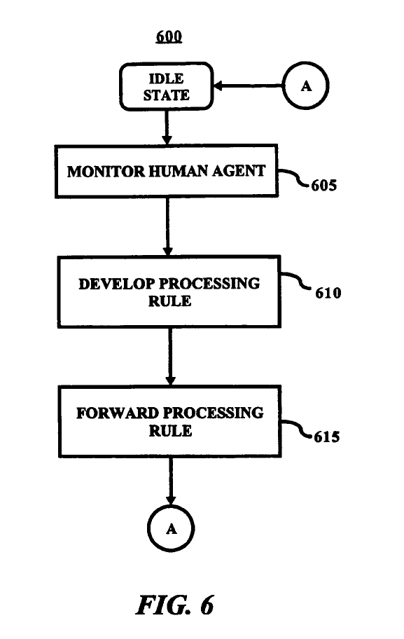

FIG. 6 illustrates a flow diagram 600 for the IVA 325, shown in FIG. 3, in accordance with yet another embodiment of the invention. It should be readily apparent to those of ordinary skill in the art that this flow diagram 600 shown in FIG. 6 represents a generalized illustration and that other steps may be added or existing steps may be removed or modified.

As shown in FIG. 6, the IVA 325 may be in an idle state, in step 605. The IVA 325, in step 610, may monitor a human agent respond to an anomaly. The anomaly may originate from the anomaly engine processor 305 or from a service call to the human agent. The IVA 325 may track the capture the screens and/or keystrokes used by the human agent responding to the anomaly.

In step 615, the IVA 325 may be configured to develop a processing rule based on the response by the human agent. For example, the IVA 325 may monitor the expert, human agent 330 may update the templates manually or accept anomalies and provide a rule to fix the anomaly. The IVA may also monitor the expert constantly repair the data free of anomalies, i.e., monitor the patterns of data being fixed, to develop a rule to detect an anomaly.

In step 620, the IVA 325 may be configured to forward the processing rule to the processing rules module 310 for subsequent processing by the anomaly engine processor 305.

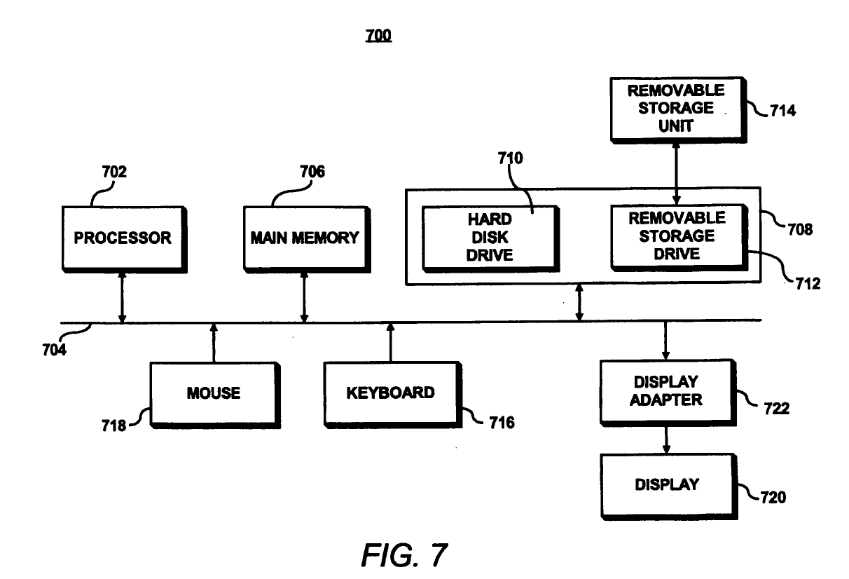

FIG. 7 illustrates a computer system implementing the anomaly engine in accordance with yet another embodiment of the invention. The functions of the anomaly engine be implemented in program code and executed by the computer system 700. The anomaly engine may be implemented in computer languages such as PASCAL, C, C++, JAVA, etc. Using any procedural or AI language.

As shown in FIG. 7, the computer system 700 includes one or more processors, such as processor 702, that provide an execution platform for embodiments of the anomaly engine. Commands and data from the processor 702 are communicated over a communication bus 704. The computer system 700 also includes a main memory 706, such as a Random Access Memory (RAM), where the software for the anomaly engine may be executed during runtime, and a secondary memory 708. The secondary memory 708 includes, for example, a hard disk drive 720 and/or a removable storage drive 722, representing a floppy diskette drive, a magnetic tape drive, a compact disk drive, or other removable and recordable media, where a copy of a computer program embodiment for the anomaly engine may be stored. The removable storage drive 722 reads from and/or writes to a removable storage unit 724 in a well-known manner. A user interfaces with the anomaly engine with a keyboard 726, a mouse 728, and a display 720. The display adaptor 722 interfaces with the communication bus 704 and the display 720 and receives display data from the processor 702 and converts the display data into display commands for the display 720.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer-readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, may be a computer-readable medium. The same may be true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

For the convenience of the reader, the above description has focused on a representative sample of possible embodiments, a sample that teaches the principles of the invention and conveys the best mode contemplated for carrying it out. The description has not attempted to exhaustively enumerate all possible variations. Further undescribed alternative embodiments are possible. It will be appreciated that many of those undescribed embodiments are within the literal scope of the following claims, and others are equivalent.

1. A method of processing data, the method comprising:
receiving at least one structured data item;
applying at least one processing rule to said at least one structured data item;
determining an anomaly associated with said at least one structured data item in response to said at least one structured data item matching a condition in said at least one processing rule; and
appending the anomaly to a database of anomalies.

2. The method according to claim 1, further comprising:
analyzing said database of anomalies; and
modifying said at least one processing rule based on the analysis of said database of anomalies.

3. The method according to claim 2, further comprising:
instantiating a virtual assistant;
querying a user on a response to an anomaly by the user; and
creating a processing rule based on the query of the user.

4. The method according to claim 3, further comprising adding the processing rule to a database of processing rules.

5. The method according to claim 4, wherein the creation of the processing rule further comprises instantiating an XML document containing the processing rule.

6. The method according to claim 1, further comprising:
analyzing a plurality of data items;
developing a pattern for the plurality of data items; and
developing a processing rule based on the pattern for the plurality of data items.

7. The method according to claim 6, further comprising:
appending the processing rule to a database of processing rules.

8. The method according to claim 7, wherein the creation of the processing rule further comprises instantiating an XML document containing the processing rule.

9. The method according to claim 1, wherein said at least one structured data item is contained in an XML document.

10. The method according to claim 1, further comprising:
instantiating a virtual assistant;
detecting a second anomaly not matching any condition in the at least one processing rule; and
mimicking a user on a response to the second anomaly by the virtual assistant.

11. The method according to claim 10, further comprising creating a new processing rule based on the response of the user.

12. The method according to claim 11, wherein the creation of the processing rule further comprises instantiating a XML document containing the new processing rule.

13. A system for processing structured data, the system comprising:
a processing rule module configured to store at least one processing rule, each processing rule configured to detect an anomaly; and
an anomaly engine configured to receive at least one structured data element, wherein the anomaly engine is also configured to determine a nearness vector for the at least one structured data element and to select a subset of processing rules based on a comparison of the nearness vector for the at least one structured data element and the respective nearness vectors of the subset of processing rules being within a predetermined value.

14. The system according to claim 13, wherein the anomaly engine is further configured to apply the subset of processing rules to the at least one structured data element.

15. The system according to claim 14, wherein the anomaly engine is further configured to determine an anomaly based on the at least one structured data element matching a condition in the subset of processing rules.

16. The system according to claim 13, wherein the processing rule module is adapted to receive additional processing rules based on analysis of the plurality of structured data elements.

17. The system according to claim 13, further comprising a pattern-matching module configured to analyze a plurality of structured data elements for a pattern.

18. The system according to claim 17, wherein the pattern-matching module is further configured to develop a new processing rule based on the pattern and to append the new processing rule to the processing rules module.

19. The system according to claim 13, further comprising a virtual assistant configured to monitor an agent.

20. The system according to claim 19, wherein the virtual assistant is further configured to monitor a response of the agent to a detected anomaly.

21. The system according to claim 20, wherein the virtual assistant is further configured to develop a new processing rule based on the response of the agent.

22. The system according to claim 21, wherein the virtual assistant is further configured to append the new processing rule to the processing rules module.

23. The system according to claim 20, wherein the monitoring is mimicking the response of the agent.

24. The system according to claim 20, wherein the monitoring is querying the agent about the response of the agent.

25. A computer readable storage medium on which is embedded one or more computer programs, the one or more computer programs implementing a method of processing structured data, the one or more computer programs comprising a set of instructions for:
receiving at least one structured data element;
maintaining a plurality of nearness vector for a plurality of processing rules, each nearness vector associated with a respective processing rule;
determining a nearness vector for at least one structured data element; and
selecting a subset of processing rules based on the nearness vector for the at least one structure data element and the associated nearness vectors for the subset of processing rules being within a predetermined value.

26. The one or more computer programs according to claim 25 further comprising a set of instructions for:
applying the subset of processing rules to the at least one structured data element; and
determining an anomaly based on the at least one structured data element matching a condition in the subset of processing rules.

27. The one or more computer programs according to claim 25 further comprising a set of instructions for:
applying the subset of processing rules to the at least one structured data element; and
determining an anomaly based on the at least one structured data element not matching a condition in the subset of processing rules.

28. The one or more computer programs according to claim 25 further comprising a set of instructions for:
monitoring a plurality of related structured data elements;
determining a pattern in the plurality of related structured data elements; and
developing a rule based on the pattern.

29. The one or more computer programs according to claim 28 further comprising a set of instructions for appending the rule to the plurality of processing rules.

30. The one or more computer programs according to claim 25 further comprising a set of instructions for:
instantiating a virtual agent;
monitoring a response by an agent to an anomaly; and
developing a rule based on the response.

31. The one or more computer programs according to claim 30 further comprising a set of instructions for appending the rule to the plurality of processing rules.

32. A means for processing data, the apparatus comprising:
means for receiving at least one structured data item;
means for applying at least one processing rule to said at least one structured data item;
means for determining an anomaly associated with said at least one structured data item in response to said at least one structured data item matching a condition in said at least one processing rule; and
means for appending the anomaly to a database of anomalies.

33. The apparatus according to claim 1, further comprising:
means for analyzing said database of anomalies; and
means for modifying said at least one processing rule based on the analysis of said database of anomalies.

34. The apparatus according to claim 33, further comprising:
means for instantiating a virtual assistant;
means for querying a user on a response to an anomaly by the user; and
means for creating a processing rule based on the query of the user.

35. The apparatus according to claim 34, further comprising means for adding the processing rule to a database of processing rules.

36. The apparatus according to claim 31, further comprising:
means for analyzing a plurality of data items;
means for developing a pattern for the plurality of data items; and
means for developing a processing rule based on the pattern for the plurality of data items.

37. The method according to claim 36, further comprising means for appending the processing rule to a database of processing rules.

38. The apparatus according to claim 31, further comprising:
means for instantiating a virtual assistant;
means for detecting a second anomaly not matching any condition in the at least one processing rule; and
means for mimicking a user on a response to the second anomaly by the virtual assistant.

39. The apparatus according to claim 38, further comprising means for creating a new processing rule based on the response of the user.
